(19) United States
(12) Patent Application Publication
(10) Pub. No.: US 2003/0036923 A1
(43) Pub. Date: Feb. 20, 2003

(54) Patient compliance and monitoring system

(76) Inventors: R. Forrest Waldon, Wilmington, NC (US); Thomas W. Leonard, Wilmington, NC (US)

Correspondence Address: Allen R. Baum, BURNS, DOANE, SWECKER & MATTHIS, L.L.P., P. O. Box 1404, Alexandria, VA, 22313-1404, US

(21) Appl. No.: 09/861,005

(22) Filed: May 18, 2001

(51) Int. Cl. G06F 17/60

(52) U.S. Cl. 705/2

(57) ABSTRACT

This invention is directed to methods and systems for monitoring compliance with or effectiveness of hormone replacement therapy. The methods and systems of the invention provide an efficient means of communication between medical professionals and patients for between visit monitoring of patient compliance with a prescribed hormone therapy and the effectiveness of the treatment recommended.

### FIELD OF THE INVENTION

The present invention relates to methods of monitoring patient symptoms, side effects and compliance with administration of prescribed therapeutic agents that are prophylactic or used to treat slow onset or chronic conditions. The present invention further provides systems for remotely assessing patient symptoms, side effects, and compliance with chronic therapeutic agents.

### BACKGROUND OF THE INVENTION

There are significant problems with patient compliance monitoring and communication in prophylactic therapies or in the treatment of slow onset conditions or diseases or chronic conditions, such as osteoporosis, vasomotor symptoms associated with menopause, vulvar/vagina atrophy associated with menopause, cardiovascular prophylaxis, neurodegenerative disease and hypertension. Symptoms resulting from these types of conditions may be difficult for the patient to accurately describe in a short office visit with medical professionals and may change as therapy is ongoing. These changes may require a review of the patient's symptoms over time to ascertain therapy effectiveness and side effects profiles. In addition, the symptoms may be difficult for medical professionals to adequately detect, diagnose, and address in the small amount of time devoted to each patient during an office visit.

In addition to addressing patient symptoms and side effects in therapies for prophylaxis, in slow onset diseases or other conditions, there is often a problem with patient compliance with the administration of recommended or prescribed therapeutic agents. In some cases the patients may discontinue therapy because acute symptoms subside. Others may stop therapy because side effects of the therapy become more pronounced or troubling than the symptoms of the disease or condition. Additionally patients may discontinue therapy because of a perceived lack of benefit or overexaggeration of risk related to therapies. In many cases patients may take the therapy sporadically or not as regularly as recommended for optimum benefit. The patient's physician may not become aware of cessation of therapy or sporadic continuation of therapy in time to address problems that may result and encourage compliance, or modify the therapy to optimize results.

A 10 to 15 minute office visit does not provide an adequate forum in which to cover these issues. In addition, office visits may not be frequent enough to address symptoms, side effects, and compliance before significant problems arise. Physicians may spend too much time addressing relatively insignificant problems of a few vocal patients while allowing patients who are not vocal or who are embarrassed to suffer needlessly or go with their questions and concerns unanswered.

Further, patients tend to relay symptoms and side effects to treating physicians that are temporally close in time to the office visit. Such short term patient reporting to the physician affects his ability to appropriately diagnose conditions, modify therapy, or understand side effect profiles developing over the course of the therapy. Physician decisions based on patient office interaction often are incorrect or of poor quality because the patient has not relayed accurate treatment information over the entire course of treatment.

There is a need for ways in which patients and physicians may communicate effectively, easily, and inexpensively between office visits while therapy is ongoing. These methods should provide for ways in which physicians may receive timely feedback on therapy effectiveness, patient compliance, adverse side effects, and unregulated symptoms, without the receipt of this information becoming too intrusive in the physician's daily duties. The methods further should allow for physician intervention where needed. These methods should also provide for convenient ways in which patients may provide information on compliance, symptoms, side effects, unregulated symptoms and concerns to physicians and feel that their concerns, problems, and questions are being adequately and timely addressed.

There further is a need in the art for methods of continuing drug monitoring programs which provide valuable treatment and outcome information while also providing important safety information to the patient.

### SUMMARY OF THE INVENTION

This invention relates to a method for improving and facilitating treatment of patients undergoing hormone replacement therapy. The method of the present invention may provide medically important information to a woman's physician, and also may provide a woman with feedback regarding her compliance with the treatment, symptoms, and side effects, and hormone replacement therapy and menopause in general.

A first aspect of the present invention is a method for monitoring compliance with or effectiveness of hormone replacement therapy comprising:

(a) initiating a patient account with an automated, interactive information system comprising an information database;

(b) posing one or more queries to be answered by a patient on a regular basis;

(c) inputting responses to the queries into the information database;

(d) compiling the responses to the queries in the information database;

(e) automatically converting the responses into digital data using the information system;

(f) automatically analyzing the digital data to generate patient information and medical professional information using the information system;

(g) automatically providing the patient information to the patient; and

(h) automatically providing the medical professional information to a medical professional.

In one aspect of the invention, the digital data are analyzed to generate a hormone replacement patient acceptability score for hormone replacement therapy. This score may be used to permit relative assessment of one patient's symptoms, side effects of hormone replacement therapy and compliance with therapy against hormone replacement therapy patient acceptability scores of other patients as collected by the information system or provided by known treatment paradigms. The one or more queries in this aspect of the invention comprise symptoms of menopause during hormone replacement therapy, side effects of hormone replacement therapy, or compliance in patient administration of hormone replacement therapy.

A further aspect of the present invention is a method for monitoring compliance with or effectiveness of hormone replacement therapy comprising:

(a) initiating a patient account with an automated, interactive information system comprising an information database;

(b) providing a patient code to allow patient access to the system;

(c) establishing patient access to the system;

(d) posing one or more queries comprising symptoms of menopause during hormone replacement therapy, side effects of hormone replacement therapy, or compliance in patient administration of hormone replacement therapy, said queries to be answered by the patient on a regular basis;

(e) inputting responses to the queries into the information database;

(f) compiling the responses to the queries in the information database;

(g) automatically converting the responses into digital data using the information system;

(h) automatically analyzing the digital data to generate patient information and medical professional information using the information system;

(i) automatically providing the patient information to the patient; and

(j) automatically providing the medical professional information to the medical professional.

The information system also may be comprised of a primary computer on which the information system is maintained and one or more remote terminals or computers interactively integrated with the information database maintained on the primary computer. The methods of the present invention may also include steps of automatically analyzing the digital data to generate pharmacist information and automatically providing the pharmacist information to a pharmacist.

Initiation of the patient account may be by a visit to a medical professional by the patient. Establishment of access to the patient account may be by the medical professional or by a pharmacist filling a prescription for prescribed hormone replacement therapy agents. The methods of the present invention system may also comprise the step of having a pharmacist who fills a prescription of hormone replacement agents for the patient issue a rebate or notice alerting a database manager that the prescription has been filled. The receipt and issuance of the rebate may be used to trigger activation of the patient code allowing patient access to the system. The method of the invention also provides for a rebate payment to the pharmacist upon issuance of the rebate or notice.

The one or more queries may relate to medically important parameters relevant to hormone replacement therapy. For example, the queries may relate to compliance by the patient to the prescribed medical treatment, side effects to the prescribed treatment that the patient is experiencing, symptoms of menopause from which the patient is suffering (both physical and psychological), patient vitals (i.e., blood pressure, weight, temperature) patient therapy acceptability and the like.

An additional aspect of the present invention is an automated, interactive system for monitoring compliance with or effectiveness of hormone replacement therapy comprising:

(a) means for posing one or more queries relevant to hormone replacement therapy to a patient;

(b) means for inputting responses to the queries into an information database;

(c) means for storing the responses;

(d) means for manipulating the responses to obtain an assessment of the patient relevant to hormone replacement therapy; and

(e) means for providing information based on the assessment to medical professionals and to the patient.

A further aspect of the present invention is an automated, interactive system for monitoring compliance with or effectiveness of hormone replacement therapy comprising:

(a) a primary computer system;

(b) an information database stored on the primary computer;

(c) an input device for receiving and transferring information from a patient to the information database;

(d) a computer program for manipulating the information to generate an assessment of the information resulting in a hormone replacement patient acceptability score; and

(e) an output device for providing information based on the assessment to a patient and a medical professional monitoring the patient's care.

The information system may also be comprised of one or more remote terminals or computers interactively integrated with the primary computer and the information database maintained on the primary computer.

### BRIEF DESCRIPTION OF THE DRAWINGS

FIG. 1 illustrates an embodiment of the method of the present invention.

FIG. 2 illustrates a method for monitoring dosing compliance.

FIG. 3 illustrates a first method for monitoring hot flash information.

FIG. 4 illustrates a method for monitoring bleeding.

FIG. 5a illustrates objective measures of vasomotor symptom frequency charted against intensity.

FIG. 5b is a graphical representation charting frequency vs intensity of vasomotor symptoms.

FIG. 5c is a graphical representation charting the number of patients vs the intensity of vasomotor symptoms.

FIG. 6 illustrates a patient's subjective view of therapeutic outcomes measuring overall vasomotor therapy acceptability.

FIG. 7 illustrates combining objective therapy measures for vasomotor symptoms with subjective patient therapy measures.

### DETAILED DESCRIPTION OF THE ILLUSTRATIVE EMBODIMENTS

The present invention relates to methods for monitoring compliance or evaluating the effectiveness of treatment for patients undergoing hormone replacement therapy. The present invention further provides a system which will monitor compliance with and/or the effectiveness of hormone replacement therapy. The information monitored by the methods and system of the invention includes medically important parameters, in particular, hormone replacement therapy related parameters, including at least symptoms, side effects, and compliance information for the patients.

The present invention also relates to automated, interactive systems for remotely monitoring compliance with and/or effectiveness of hormone replacement therapy. The methods and systems of the present invention provide for convenient, effective, and efficient communication between physicians and patients. Based on the patient's personal observations (both objective and subjective), the methods and systems of the present invention provide information to the patient's medical professionals and provide information to the patient. Further, the system analyzes the information gathered as well as summarizes the information.

The methods and systems of the present invention provide an efficient means of communication between medical professionals and patients for between visits monitoring of patient compliance with a prescribed hormone replacement therapy and the effectiveness of the treatment recommended, including side effects associated with therapy. Moreover, the methods and systems of the present invention may provide a means of communication for situations where communication between a medical professional patient is difficult or cut short due to the practical time considerations of office visits, or where communication is inaccurate due to a failure of the patient's to adequately report symptoms and side effects of therapy over the course of treatment.

It has been found that patients may drop out of therapy due to ineffectiveness of therapy and/or due to side effect issues without regular feedback from physician to patient. Moreover, patients are often unable to relate symptom remediation and side effects over long periods of time between doctor visits. Finally, medical professionals cannot modify therapy if they are unaware of the actual status of a patient's treatment because of not receiving timely feedback.

The present inventors have developed methods and systems which enable increased communication between physicians and patients undergoing hormone replacement therapies and patient therapy feedback.

Definitions:

Unless otherwise stated, the following terms used in the specification and claims have the meanings given below:

A “hormone replacement therapy patient acceptability score” is any scoring system or relative comparison that permits relative and/or subjective assessment of symptoms of menopause during hormone replacement therapy or any assessment of side effects of hormone replacement therapy or compliance in patient administration of hormone replacement therapy.

“Menopause” includes perimenopause and postmenopause and refers to the events and conditions leading to and associated with the cessation of menstruation in the human female, whether naturally or artificially occurring, and continuing for the remainder of a female's life;

“Medical professionals” mean any member of the medical profession who is attending to the physical or mental health of a person. Medical professionals may include, for example, nurses, physicians, psychiatrists, physician assistants, and the like.

“Effectiveness of hormone replacement therapy” means whether or not the therapy provides the desired control of conditions and symptoms to be treated by such therapy, including the presence or absence of side effects associated with the therapy and the intensity of such side effects, as well as the assessment of other factors associated with the therapy which are determined to be suitable for monitoring during the therapy period.

In one aspect of the method of the present invention a patient account is initiated with an automated, interactive information system. The automated, interactive system may be maintained on a primary computer system and may be comprised of an information database. The information system may also be comprised of a computer program or software product for compiling, converting, and manipulating data and generating output information based on the data. The computer program or software product may be written for use with the information system of the present invention or may be a commercially available program or software modified for use with the information system. The program may be written in any appropriate computer language, such that it is compatible with the hardware and software used to carry out the input, storage and analysis of the data.

The information system may also be comprised of one or more remote terminals or computers interactively integrated with the primary computer on which the information database is maintained. These remote terminals or computers may communicate with the primary computer by any means known to those of skill in the art such as through the Internet, modem-to-modem hook-up and the like. In a preferred aspect of the invention, the remote computers communicate with the primary computer via an Internet connection.

By way of example, to initiate an account with the automated, interactive information system of the present invention, a patient suffering from symptoms of menopause or patients already undergoing hormone replacement therapy may schedule an appointment with a medical professional. The patient account with the automated, interactive information system may be initiated by the medical professional as part of the treatment regime for the patient. By way of example, the medical professional may make a diagnosis that hormone replacement therapy is an appropriate treatment for the patient. After making the diagnosis and discussing hormone replacement therapy with the patient, the physician may provide the patient with a prescription for hormone replacement agents and an initiation kit for registering with the information system of the present invention. Typically, hormone replacement therapy will involve administration of one or more estrogens, one or more progestins, and/or one or more androgens, optionally in conjunction with additional therapeutic agents.

As an additional example of ways in which to initiate an account, a patient taking hormone replacement agents may self-initiate an account by requesting an initiation kit. Patients taking hormone replacement agents may be targeted for self-initiation by directed mailings; by information included with prescriptions for hormone replacement therapies; by information included with products frequently purchased by individuals who may be taking hormone replacement agents; by information included in books, magazines, commercials, or other entertainment or educational media frequently consumed by individuals who may be taking hormone replacement agents; and the like. Patients may be advised to contact the information system directly for an initiation kit, or patients may be advised to contact a medical professional, a pharmacist, or the like for a kit. Additionally, a managed care organization may decide to enroll all patients under its care on hormone replacement therapy in the program and initiate accounts for a block of patients.

As a further example, a patient account may be initiated by a pharmacist who fills a prescription for a hormone replacement agent. A pharmacist filling a prescription for hormone replacement agents may provide the patient with the requested agent and an initiation kit for registering with the information system of the present invention. The information system may be set up so that it is possible to initiate an account by only one of these ways, all of these ways, or any combination thereof. Other methods of account initiation may be devised.

Access to an account may be free, thereby considered to be part of the therapy, or may be provided for a monthly or yearly maintenance fee.

Registration may occur concurrently with the patient receiving the initiation kit.

Registration of the patient with the information system may occur by any means in which information identifying the patient may be transmitted to the information system. Information identifying the patient may be gathered by completion of a standard form included in the initiation kit. The form may indicate whether the patient prefers access to the system via electronic, telephonic, or manual means. The form may indicate appropriate contact information based on the access means selected. The form also may indicate patient dosing, patient vitals (for example, age, weight, blood pressure, and the like), and patient conditions (for example, high cholesterol, high blood pressure, breast cancer, and the like). The form may indicate a unique patient code assigned to identify that patient and allow the patient access to the information system. The form may also indicate contact information for the medical professional from whom the patient is seeking treatment.

The health or medical professional may complete the form or may utilize the help of the patient or pharmacist. The completed form may be sent to the information system by the patient, the medical professional, or the pharmacist. By way of example, the nurse may complete the form with the help of the patient at the medical professional's office during the office visit. The nurse or office administrator may send the form to the information system. The form may be sent to the information system by any way in which the information system may reliably receive the form. For example, the form may be sent by facsimile, by scanning into electronic media and sent electronically, by mail, and the like. An electronic form may be used in lieu of a paper form.

The initiation kit may also contain literature describing features of the automated, interactive information system of the present invention, literature describing how to use the information system, literature describing hormone replacement therapies and menopause in general, sample products in which the patient may be interested, coupons for products in which the patient may be interested, videotapes containing pertinent information, internet website information, and the like.

After receipt of the completed form, a patient account may be established on the information system based on the information on the form. The patient account may be identified by the unique patient code assigned to identify the patient for whom the account has been established. The information from the form, including the patient information and medical professional information, may be included in the patient account and used to identify that particular patient account as corresponding to the particular patient.

After the patient account is established, the patient account needs to be activated so that the patient may have access to her account. The account may be activated in any way such that the information system is notified that the patient has procured her prescribed hormone replacement agents and is ready to begin treatment. The patient account may be activated automatically upon establishment or may require a separate activation step. Additionally, the patient account may be activated for a limited time or on a temporary basis unless confirmed by the pharmacist or patient.

By way of example, the patient may take her prescription for hormone replacement agents to a pharmacist. The pharmacist may fill the prescription and send in a pharmacist rebate to the information system. Receipt of the rebate may be used by the information system to indicate that the patient has procured the prescribed therapeutic agents and is ready to begin treatment. The purpose of the rebate is to link the rebate code to a patient code, making sure the patient is on a particular therapy. At that time, the information system is signaled to activate the patient account. The rebate may be sent to the information system by any way in which the information system may reliably receive the rebate. For example, the rebate may be sent by facsimile, by scanning into electronic media and sent electronically, by mail, and the like. The rebate may also go to a third party, i.e., a rebate processing company who would then notify the necessary parties.

As an additional way in which the account may be activated, the patient may send a second form to the information system herself, indicating that the patient has filled her prescription and is ready to begin treatment. The second form may be sent by, for example, facsimile, scanning into electronic media and sending it electronically, mail, and the like. Upon receipt of the rebate or second form indicating that the patient has filled her prescription for hormone replacement agents, the patient's account with the information system may be activated.

As an alternative, the patient account with the information system may be activated upon establishment of the account and a separate activation of the account may not be required. A separate activation of the account is not required; however, it may be used to verify that the patient fills her prescription for hormone replacement agents. A frequent problem with patients prescribed hormone replacement agents is failure to fill the prescription and begin treatment after the patient leaves the medical professionals' office. Initiation of the patient account by the health professional when the prescription is written followed by a separate activation step completed by the pharmacist or patient may be used to encourage the patient to fill her prescription and begin treatment.

Upon receipt of the rebate or second form indicating that the patient has received appropriate hormone replacement therapy, the patient's account with the information system may be activated. Patients with accounts established for which no rebates or second forms are received to activate the accounts may receive communications (for example weekly, bimonthly, and the like) reminding the patients of the importance and benefits of hormone replacement therapy and encouraging the patients to have their prescriptions filled and to begin treatment. If a rebate or second form is not received after a set amount of time (for example, two weeks, two months, three months) for an account in which activation is required, the account may be terminated and the patient may be notified of termination and encouraged to see her doctor. If the account is terminated for failure to activate, the doctor may also be notified of the patient's failure to fill her prescription.

For each patient for which a completed form and a pharmacist rebate or second form is received, an account may be initiated on the information system and activated. The account may be accessible only to the particular patient. The patient may access her account using the unique patient code and may be allowed to create a personal password for future access to the account. If the patient selected electronic access to the information system, the patient may access the information system from a remote terminal or computer interactively integrated with the information system maintained on a primary computer. Upon initiation of access, the patient may be presented with a point and click format for easy use. In a preferred aspect of the invention, patients who have selected electronic access to the information system will access their accounts via the Internet. The Internet interface may be set up any of a number of ways. For example, the home page for the information system website connection may include websites directed to the particular hormone replacement agent, as well as sites directed to particular symptoms and side effects. Additionally, the website utilized will provide access to educational materials related to hormone replacement therapy, menopause and other relevant issues.

If the patient selected telephonic access, the patient may use an automated telephone interface to access the information system. Using the automated telephone interface, the patient may access the information system by pressing keys on the telephone as prompted. If the patient selected manual access, the patient may access the information system by manually completing information cards and sending these cards to the information system. These completed cards may be sent to the information system by, for example, mail, facsimile, or dropped off at the physician's office or pharmacist to be forwarded to the information system. The cards may duplicate the data collection fields on the electronic site.

The information system may be used to pose one or more queries relevant to hormone replacement therapy to a patient. These one or more queries may be answered by the patient on a regular basis. The patient may have some freedom in selecting the one or more queries to which she will respond based on the type of hormone replacement therapy prescribed and the type of symptoms and side effects suffered by the patient.

The form of the queries and the manner in which they are posed and answered may depend upon the access method selected by the patient. If electronic access is selected, the patient may log onto the electronic site, for example, an Internet web site, using a computer or terminal interactively integrated with the information system maintained on the primary computer. The queries may be posed and responses may be entered using a point and click format. If telephonic access is selected, the patient may be prompted to use an automated telephone interface to provide responses. The patient may be prompted to use the automated telephone interface by an automated telephone call that connects the patient to the interface. This telephone call may be received at a time preselected by the patient as convenient. The patient may also be prompted to use either the electronic site or the telephone interface by a reminder card that is mailed or emailed to the patient reminding her to access the system. A patient may also select a satellite interface or an interface with a hand-held device with a computer interface.

If, for example, manual access is selected, the patient may be provided with a supply of cards duplicating the data collection fields on the electronic site. These cards may be contained in the initiation kit or the cards may be mailed to the patient on a regular basis to be completed and returned. The cards may be sent to the information system by mail, by facsimile, or by drop off at the physician's office or pharmacist.

The one or more queries typically are directed to one or more medically important parameters relevant to hormone replacement therapy to a patient. For example, the queries may be directed to compliance by the patient in taking the prescribed hormone replacement agents as directed. In addition, the queries may be directed to side effects to the prescribed treatment that the patient is experiencing (both physical and psychological). The queries may further be directed to symptoms of menopause from which the patient is suffering (both physical and psychological). The queries may be used to solicit information or feedback from the patients for any medically relevant parameter or any parameter relevant to hormone replacement therapy.

The patients may be requested to respond to all of the queries posed. In the alternative, patients may select the queries to which she will respond. Responses to the queries may include compliance information as well as both the frequency and the severity of the medically important parameter for which information is requested. Responses to the queries may include an subjective assessment by the patient of the whether the frequency and severity of a particular medically important parameter, such as a symptom or side effect, is acceptable, troublesome, or unacceptable. This subjective assessment can be factored into the algorithm used to calculate a score for interpretation against the appropriate paradigm standard.

Responses to the queries may be input into the information system. The means for inputting responses to the queries into the information database may comprise transferring the responses electronically from a remote computer or terminal to a primary computer, wherein the responses are electronically input into the information system. The means for inputting responses may also comprise transferring the responses to a primary computer using an automated telephone interface, wherein the responses are electronically input into the information system. The means for inputting responses may additionally comprise manually recording the responses on cards, scanning the cards into electronic format, and electronically transferring and inputting the responses into the information system. The means for inputting responses further may comprise manually recording responses on cards and manually inputting the responses into the information system.

In one aspect of the invention, an input device for receiving and transferring information from a patient to the information database is used. Any device which can accomplish the task of receiving information and transferring the same may be used. Preferably, the device will be a computer with a connection to the primary computer on which the database is stored.

In one aspect of the invention, responses to the queries may be stored and compiled in the information system. Preferably, responses to the queries are converted into digital data for easier manipulation by the system. The responses and/or digital data may be manipulated and analyzed to generate an assessment of the information provided by the patient. In one aspect, the responses to the queries are compiled using analysis algorithms of treatment outcomes. The results of the analysis may be combined with hormone replacement therapy patient acceptability scores and used for comparisons with other patient scores or expected scores obtained from a treatment paradigm.

In one aspect of the invention, the information system may be comprised of an information database and one or more computer programs or software products for storing, compiling, converting, manipulating, and analyzing the responses to the queries. The information database and the computer program or software product may be written for use with the information system of the present invention or may be any commercially available program or software which may be modified for use with the information system. The responses and/or digital data may be manipulated and analyzed by comparison to set patient standards or may be manipulated and analyzed by algorithms and statistical information.

The responses to the queries may be stored, compiled, converted, and manipulated and analyzed to obtain an assessment of the one or more medically important parameters to which the responses and queries relate. From this assessment, patient information, physician information, pharmacist information, and the like may be automatically generated and provided to the appropriate individual(s). For example, based on an assessment of the responses, the information system may automatically generate appropriate information that is to be provided to the patient, physician, the pharmacist, and the like. This information may relate to the information system's assessment of the one or more medically important parameters. For example, the information may relate the patient's compliance, side effects, and/or symptoms.

As indicated, for example, patient interface with the program may be carried out manually or electronically. Point and click screens may be used for the electronic patient interface. The manual interface may utilize hard copy forms suitable for direct optical scanning into the database. Calendar formats may be used to input data on a daily, weekly or monthly basis. Data relative to frequency of medication dosing, symptoms, and side effects may be input on a daily or weekly basis. Scales relative to severity of symptoms, and side effects may also be included. A general treatment standard paradigm for symptoms and side effects for each aspect to be monitored preferably is established and used as a baseline for therapy evaluation. Thus, individual patient data will be compiled using algorithms to generate symptom and side effect scores, including a hormone replacement therapy patient acceptability score, that can be interpreted relative to the general treatment standards. Outcomes are established based on patient scores relative to the treatment standards. Examples of treatment standards and outcome flowcharts for symptoms and side effects are given in the Figures. The individual patient data may be maintained on the system for certain intervals, allowing medical professionals access to the specific symptom, side effect, and compliance data provided by the patient.

Patient data collected are analyzed based upon both objective and subjective parameters. Resulting data may be screened against predetermined treatment paradigms established by leading medical professionals with expertise in the measurement parameter. As outcomes data are accumulated through enrollment of patients, these established medical paradigms are challenged and modified based upon statistical analysis of actual patient outcomes, including therapy outcomes and side effects, as well as dosing strength and regimen response. The ability to collect data over an extended period of the treatment period and provide an analytical result based upon chronic information is an important tool in hormone replacement therapy. Such statistical analysis on a broad patient population adds significant data regarding patient outcomes optimization and safety information with respect to the therapy drug. This type of information traditionally has been collected through adverse event drug reporting (directly to the pharmaceutical company) or prospectively designed post-approval drug studies (submitted to the FDA) by the pharmaceutical company. In either such case, treating medical professionals and patients do not receive information feedback sufficient to have a timely effect on therapy continuance or other pertinent treatment decisions. While adverse event reporting and/or post-marketing studies may have some future outcome value, neither assist in real-time patient care or provide individualized treatment feedback.

The invented system collects information from patients which continues to drive statistical models regarding “optimized” patient outcomes, including efficacy and side effects profiles and allows statistical determination of sub-optimal parameters, assisting the treating medical professional with “acceptable” vs. “unacceptable” treatment decision-making. Such feedback is useful in determining whether or not a patient's dosage strength, regimen, and/or, in some instances, drug choice is appropriate. Prior to this invention, such “real-time” objective treatment measures and feedback mechanisms were unavailable to the treating medical professional or patient.

In addition to gathering objective compliance, effectiveness, and/or side effect information, the present invention also measures subjective patient parameters, including, for example, such subjective patient parameters as perception of therapy effectiveness, symptom and side-effect tolerability, and other extraneous unanticipated effects (e.g. libido effects). These patient-specific subjective parameters are critical for successful drug continuance/compliance and patient acceptance of therapy results. Understanding the patient's perceived acceptance, tolerability, and evaluation of results, coupled with the objective measures of the drug's effectiveness/side effects (collectively, “outcomes”) are integral to appropriate dosing decisions as well as requisite feedback to the patient to maintain the patient on therapy when appropriate.

For example, if a patient is having objectively successful treatment outcomes, but does not recognize the beneficial result, she may terminate therapy or fail to comply with dosing, or alternatively may require intervention (by way of appointment or phone call to the treating medical professional), when appropriate and timely feedback from the monitoring system regarding an objective assessment of therapy effectiveness may result in reducing or eliminating dissatisfaction or concerns with the treatment, encouraging compliance and avoiding unnecessary medical professional intervention.

Also, by way of example, if a patient who is objectively having unsuccessful treatment outcomes, but perceives a positive treatment experience, or fails to understand that such treatment outcomes are sub-optimal, such patient is unlikely to request medical professional intervention or report negative results at scheduled appointments, resulting in continuing adherence to inappropriate or sub-optimized therapy. This invention intervenes by providing timely feedback to both the medical professional and patient, allowing the medical professional to intervene by modifying therapy or by either party requesting an appointment.

Obtaining objective treatment outcomes analyzed by tailored treatment paradigms (continually modified by a growing drug-specific statistical base) and subjective patient inputs combined with effective, timely healthcare professional and patient feedback optimizes patient therapy. It encourages compliance and effective dosing decisions, and avoids unnecessary side effect complications.

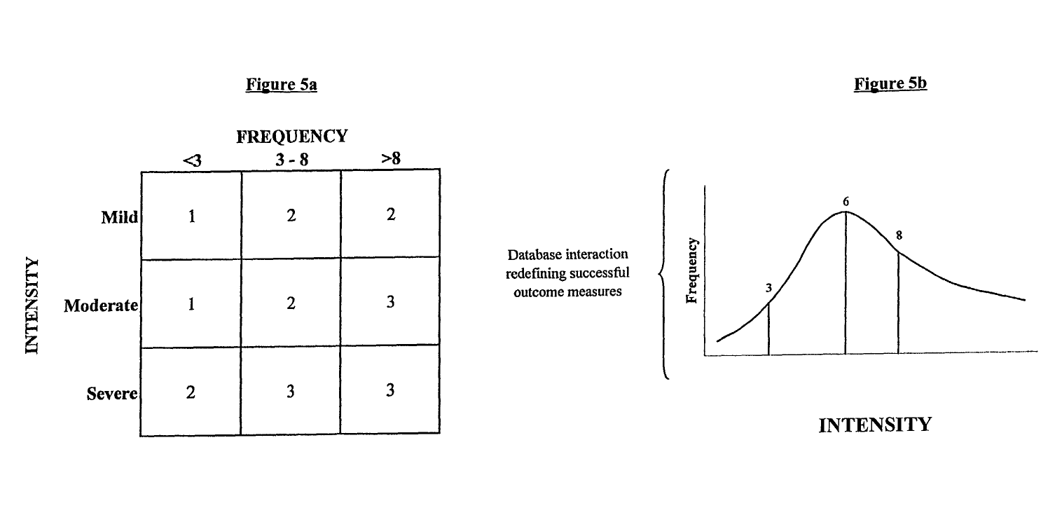

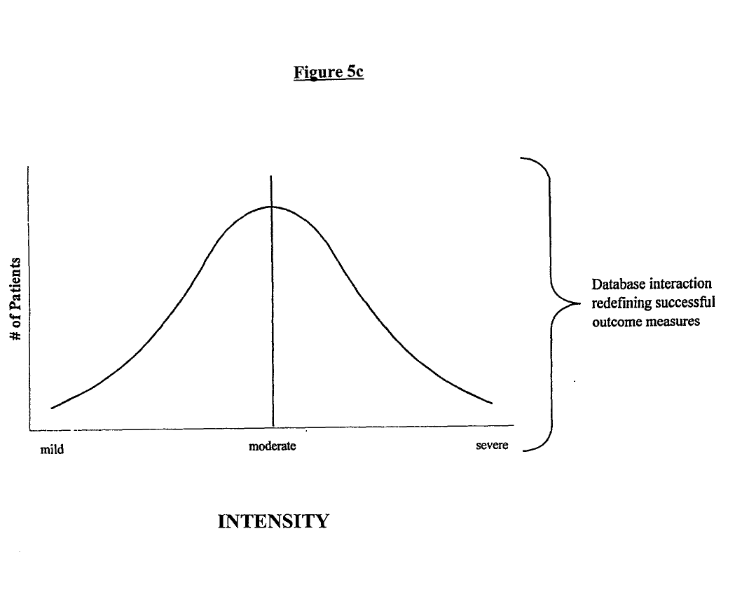

By way of example, illustrations of the merging of objective treatment outcomes decision parameters and subjective patient feedback are shown in FIGS. 5, 6, and 7 for vasomotor symptoms.

FIGS. 5a, 5b and 5c represents objective measures of vasomotor symptom frequency charted against intensity. Each box in the chart of FIG. 5a is numbered 1, 2, or 3, representing successful therapy, troublesome therapeutic results, or therapy failure, respectively. Objective definitions for counting hot flashes and measuring intensity are well-known to those skilled in the art as today's treatment paradigm. The graphs of FIGS. 5b and 5c illustrate frequency vs. intensity and the number of patients vs. the intensity, respectively, of the vasomotor symptoms and allow for database interaction which redefines successful outcome measures. The invention's data collection system allows statistical refinement of what constitutes successful, troublesome, or failure of therapy based upon continuing analysis of large and expanding patient populations on a drug, strength, and regimen specific basis.

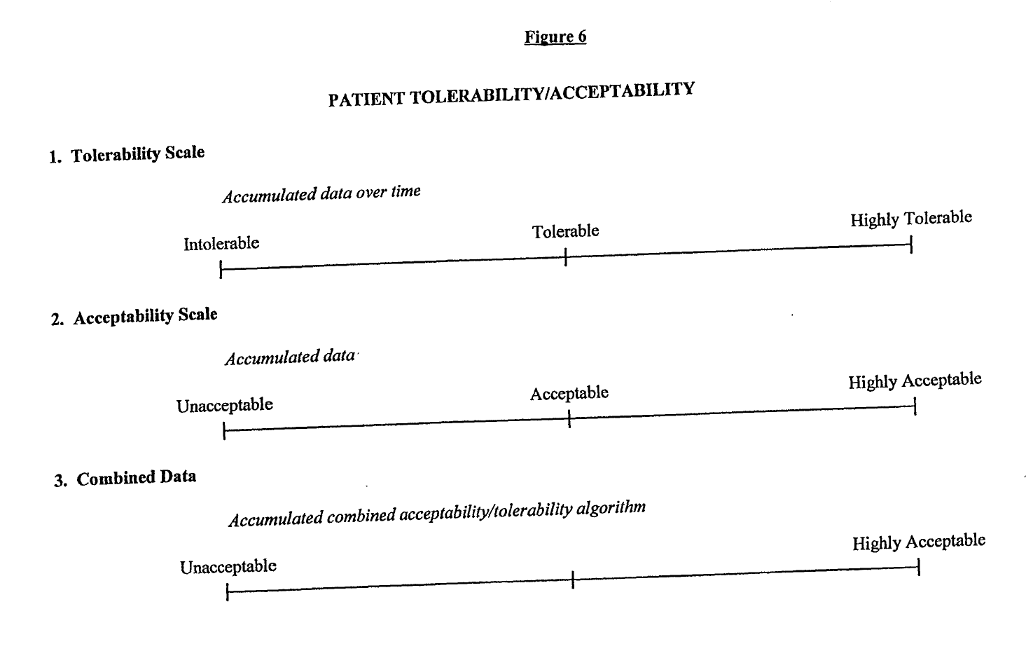

FIG. 6 illustrates a patient's subjective view of therapeutic outcomes measuring overall vasomotor therapy acceptability through combined weighted individual parameters such as therapy tolerability and acceptability over time. Additional subjective measures could also be added.

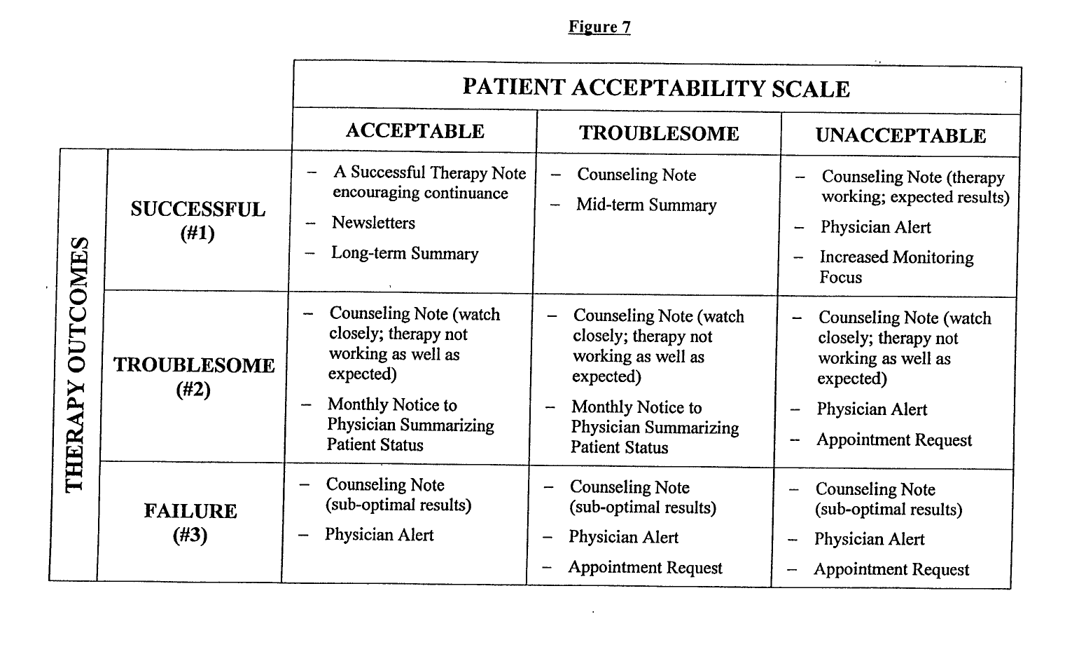

FIG. 7 illustrates combining objective therapy measures for vasomotor symptoms (FIG. 5) with subjective patient therapy measures (FIG. 6) to provide the invention system responses to the patient and treating medical professional. Each intersecting box represents system feedback for varying treatment (objective and subjective) outcomes.

The above illustrations demonstrate how various data may be collected, analyzed and reduced to feedback responses. Other measures could include objective measures, such as side effects (e.g. bleeding, bloating, breast tenderness) or indicated treatment outcomes (e.g. bone density measures, bone metabolic marker plasma or excretion measures), and subjective measures (perceived mood changes, libido, sexual satisfaction and other factors related to healthy sexual function, tiredness, extraneous symptomatology).

After the information in the information database is assessed, an output device may be utilized for providing information based on the assessment to the appropriate individuals. Such an output device may be an electronic communication device for delivery of email, a printer attached to the primary computer and the like. Any such output device known to those of skill in the art may be used.

The information that may be provided to the patient may include, summaries, educational quarterly newsletters, educational monthly newsletters, educational materials relating to a specific area of concern, a recommendation that the patient consult medical professionals concerning a particular side effect or symptom, a warning that the patient's symptoms or side effects are abnormal and an advisory to make an appointment with her physician and possibly a warning to discontinue medication until the physician is contacted, and the like. The patient may also be directed to use the telephone to get further information from a recorded message or to talk to a nurse. For example, in the event that the patient's responses to the queries indicated that the patient is responding poorly to therapy or experiencing unacceptable levels of side effects, the patient may receive a “patient alert” to consult with her physician regarding that side effect or symptom or may receive a “patient alert” to make an appointment as soon as possible with her physician.

The information that may be provided to the medical professionals may include, monthly summaries of the patient's side effects, symptoms, and compliance, weekly summaries, a doctor advisory on a particular symptom/side effect, a doctor warning containing a recommendation that the physician or administrative staff contact the patient to advise scheduling an appointment, and the like. For example, in the event that the patient's responses to the queries indicated that the patient is responding poorly to therapy or experiencing unacceptable levels of side effects, the physician may receive a “doctor warning” to contact the patient to recommend scheduling an appointment or to reevaluate therapy.

Similar information as sent to the medical professionals may also be sent to the pharmacist. With receipt of the appropriate information, the pharmacist may address patients' questions and concerns when having their prescription refilled. The pharmacist may also address compliance issues when refilling patients prescriptions. If recommended or deemed necessary, the pharmacist may also recommend that the patient schedule an appointment with her physician.

If the assessment indicates that the patient is meeting therapeutic standards relative to efficacy, adverse reactions, compliance, and the like, information may be provided to the patient and medical professional and at longer standard time intervals, for example, quarterly. If the assessment indicates that the patient is not meeting therapeutic, adverse effects standards, adverse symptom standards, or compliance standards, information may be provided more frequently as needed to adequately address the problems. If the assessment indicates particularly problematic therapeutic, adverse effects, adverse symptoms, or compliance, information in the form of an advisory or a warning may be provided immediately that an appointment with a medical professional is needed.

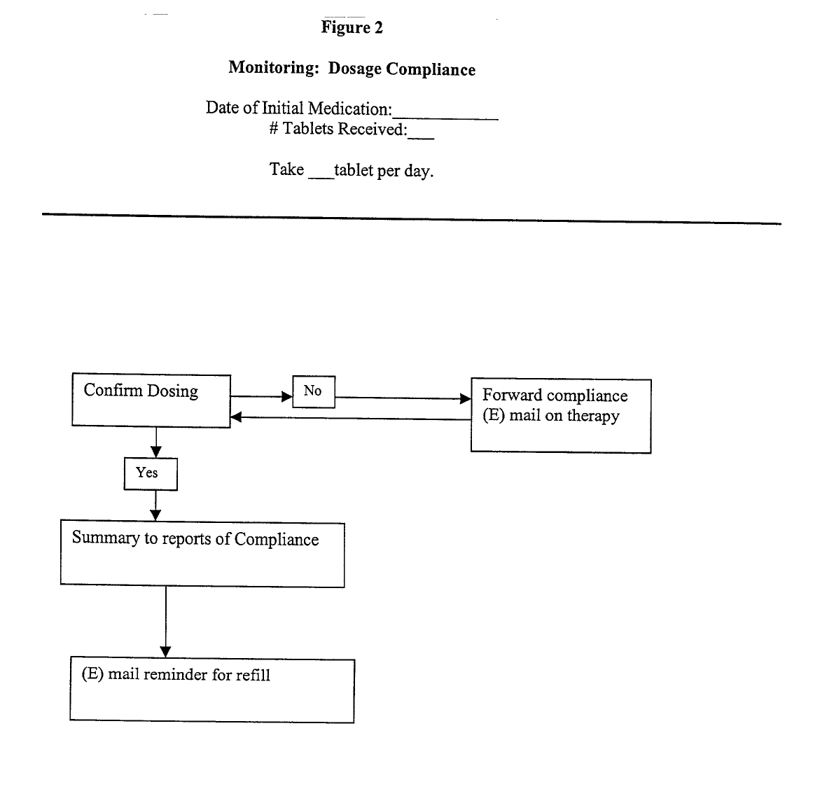

The queries may be used to solicit information or feedback from the patients for any medically relevant parameter. By way of example, the queries may be directed to compliance by the patient in following the prescribed hormone replacement treatment and thus may prompt the patient to provide information regarding compliance. FIG. 2 illustrates a possible method for obtaining dosing compliance information according to the present invention. A response to queries directed to dosing compliance may be required. Patient dosing compliance is directly related to the therapy's effectiveness and adverse reactions/side effects. The queries may be used to confirm dosing, the number of tablets taken per day, the time at which the tablets are taken, and the like. The information system may used to track the dosing and/or number of tablets received in the prescription, and determine when a refill may be necessary. The information system may be used to send a reminder, by email, mail, automated telephone call, among others, to the patient to remind the patient to refill her prescription.

The information provided concerning patient compliance may be used to provide the patient's physician with information with regard to the patient's treatment. Patients entering responses that indicate a lack of adequate compliance may signal the information system to automatically provide the patient with educational information regarding the importance and benefits of continued, regular therapy. This information may be provided electronically, telephonically, or in print by mail. In addition, patients entering responses that indicate a lack of adequate compliance may signal the information system to automatically provide the physician with an alert that the patient is not adhering to the treatment regimen. The medical/administrative staff may follow up with a phone call to the patient or discuss treatment compliance when the patient comes in for the next office visit. A note may also be put in the patient's file so that the physician may have the patient compliance information when addressing symptoms that the patient is experiencing.

The queries may also be directed to side effects to the prescribed treatment that the patient is experiencing (both physical and psychological). In addition, the queries may be directed to symptoms of menopause from which the patient is suffering (both physical and psychological). The queries further may be directed to results of home-based monitoring of bodily fluids, such as blood and urine, to the extent such tests are available to monitor physiological levels related to hormone decline. Such tests may include those which measure such factors as bone metabolic marker plasma or excretion, among others. The patient may select the queries directed to side effects and symptoms that she is interested in responding to. For example, the patient, medical professional or pharmacist typically may select only those queries directed to side effects and symptoms that she is currently experiencing or about which she is concerned.

The queries may be directed to tracking the frequency and severity of symptoms that the patient is experiencing due to declining hormone levels (i.e., symptoms of menopause), including, for example, hot flashes, osteoporosis markers, declining libido, sexual dysfunction, vaginal atrophy, vaginal dryness, reddening of the skin on the face, neck and chest, joint pain, urinary incontinence, skin dryness, dizziness, headache, weakness, mental anguish, depression, inability to concentrate, memory loss, insomnia, nervousness, irritability, abrupt mood swings, and the like. In addition to tracking the frequency and severity of the symptoms, the queries may track whether the patient assesses what she is experiencing to be acceptable, troublesome, or unacceptable.

The queries may further be directed to tracking the frequency and severity of hormone replacement therapy side effects, including, for example, breakthrough bleeding, migraines, weight gain, breast tenderness, bloating, hypertension, nausea, vomiting, diarrhea, leg cramps, intolerance to contact lenses, and the like. The queries may be structured to evaluate both the frequency of the symptoms or side effects experienced and the severity. In addition to tracking the frequency and severity of the side effects, the queries may track whether the patient assesses what she is experiencing to be acceptable, troublesome, or unacceptable.

The queries may be responded to daily, weekly, biweekly, and the like. The patient may also have an opportunity to send or enter additional comments, concerns, or questions that will be directed to a nurse, the physician, or the pharmacist. If a certain period of time passes with no entry of responses from the patient, for example 30 days, the patient may be reminded to enter responses. The reminder may be sent via email, automated phone call, or mail.

The responses to the queries, including the frequency, severity, and assessment, may be converted to digital data and the digital data may be manipulated and/or analyzed by an algorithm or computer program. The manipulation and/or analysis of the data may be used to generate the patient information and medical professional information. The information system of the invention thus provides a means for determining the needs of the patient and transferring that information to a medical professional in charge of the care of that patient. The system further provides a means for providing additional information to the patient where the algorithm or computer program determines such is needed. In a preferred aspect of the invention, the software product or computer program is designed such that the input information from the patient is manipulated and analyzed according to specifications corresponding to hormone replacement therapy requirements and current treatment paradigms, and is refined by statistical information gathered on the patient population. For example, this analysis may provide a hormone replacement therapy patient acceptability score for each patient which is used to provide statistical information for all patients who have provided information to the system.

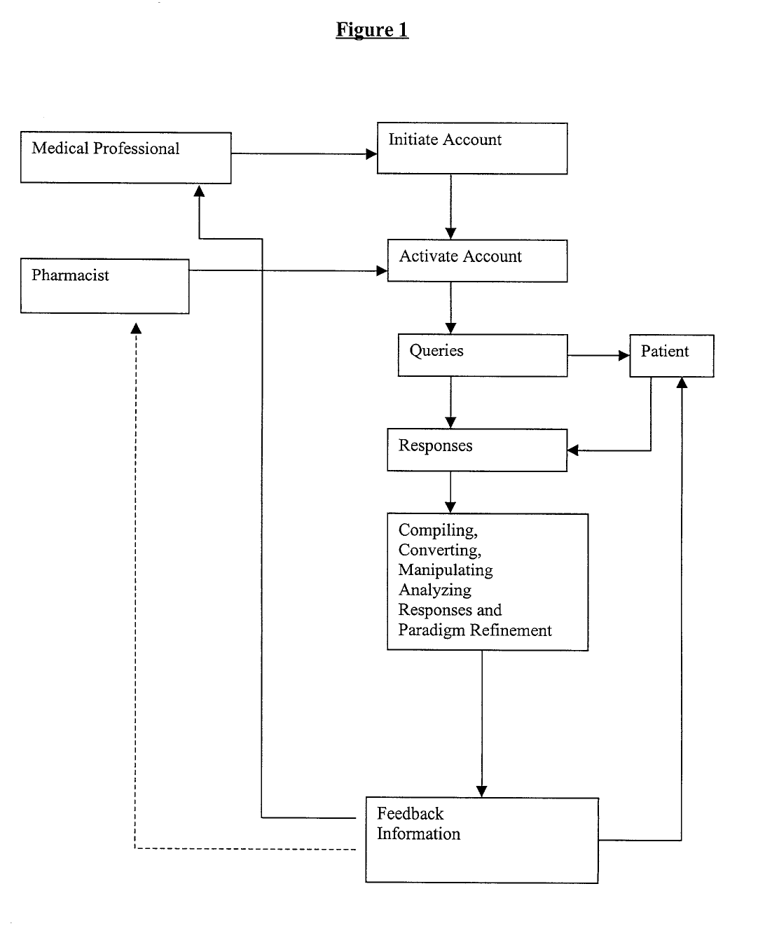

FIG. 1 is an illustrative embodiment of the method of the present invention. An account is initiated by the medical professional, typically during or after a medical visit by the patient. When the patient fills a prescription for hormone replacement therapy agents, the pharmacist activates that patient's account. The information system then generates queries to the patient, concerning compliance with the therapy, side effects, symptoms or other related matters, through whichever means have been selected by the patient. The patient's responses to the queries are input into the information system and transferred to an information database. The information database is utilized by the information system to compile, convert, manipulate and analyze the responses to the queries posed to the patient. Once the responses have been compiled and converted to information in a format useable by the primary computer system, the information and/or data are analyzed according to parameters provided by the computer program or software product. The treatment paradigm may then be refined, as needed, based on the analysis of the input information. This analysis results in feedback information being generated which is then sent to the patient, the medical professional, the pharmacist or any combination thereof.

In actual operation of the method of the invention and the information system of the invention, for example, the patient may be prompted to input information as to the number of times she has experienced a particular symptom, for example, hot flashes or vasomotor symptoms, urinary incontinence, insomnia, and the like, per day (week, month, etc. as appropriate for that symptom) for a set time period (i.e. week, month, two weeks, etc). The patient may also select the queries relating to symptoms and side effects to which she would like to respond. By selecting queries, the patient may respond to only those queries related to her side effects and symptoms. Then the patient may be prompted to rate the severity of the symptom(s) experienced each day (or week, month, etc. as appropriate for that symptom) as, for example, mild, moderate, or severe. The patient may be prompted to assess the symptom(s) experienced each day (or week, month, etc. as appropriate for that symptom) as, for example, acceptable, troublesome, or unacceptable. The patient may input all of her information into the information system electronically using a remote computer interactively integrated with the information system. For example, the patient may access her account on the information system via the internet by logging onto the website for the information system and may enter her information using a point and click format.

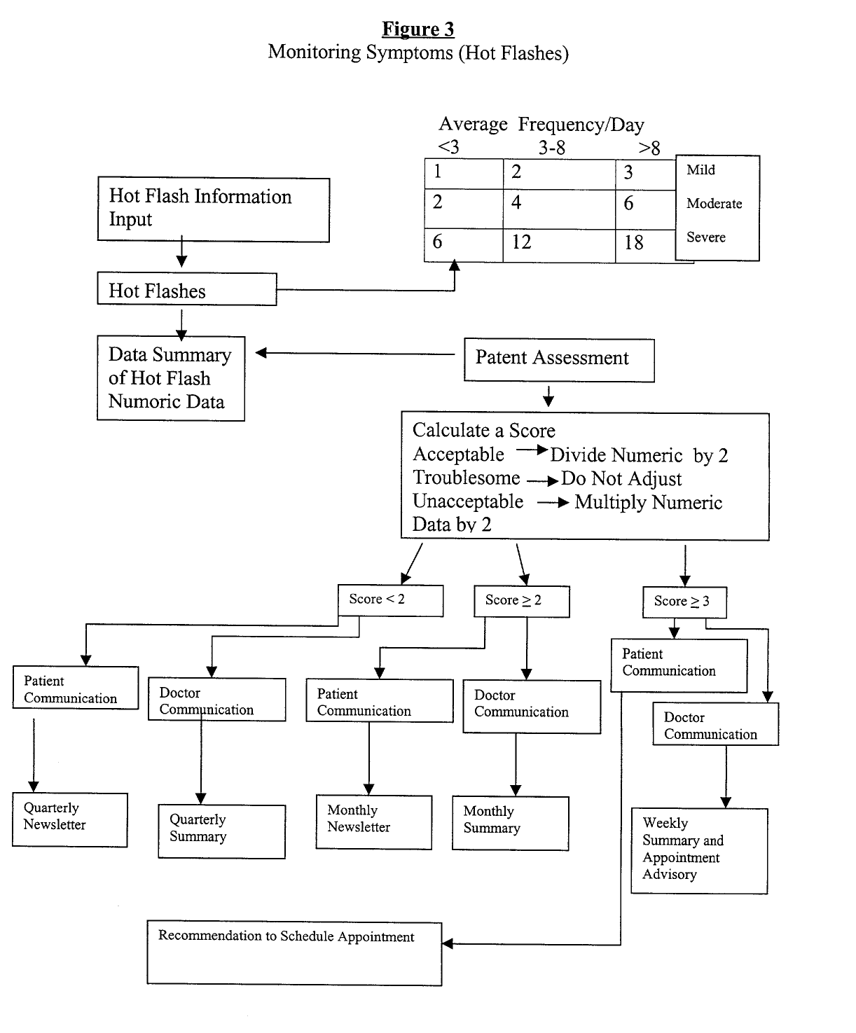

The information that the patient input in response to the queries will be stored, compiled, converted, manipulated, and/or analyzed to generate output by the information system. The analysis may further generate an hormone replacement therapy patient acceptability score. For example, based on the patient's log of the number of times she has experienced a particular symptom per set time period (i.e. day, week, month, etc.), an average frequency per set time period and average severity per set time period may be calculated. Using the average frequency and the average severity, a number may be assigned. For example, as shown in FIG. 3, if the average frequency per day of a hot flash is less than 3 and the average severity is mild, the number 1 may be assigned. If the average frequency is 3-8 and the average severity is moderate, the number 4 may be assigned. Based on the patient's evaluation of the symptom(s) as acceptable, troublesome, or unacceptable, an operation may be performed on the assigned number and a final number or score may be calculated. The final number or score may be used to indicate the information to be sent to the patient and medical professional.

As an alternative, the patient's evaluation of the symptom(s) as acceptable, troublesome, or unacceptable may not be involved in determining the information to be sent to the patient and medical professional. In this example, the information to be sent may be determined using the average frequency and the average severity of the symptom without further manipulation according to subjective data.

The system may be set up such that certain input from the patient will trigger the information system to monitor the patient's condition, for example, conduct a review of patient input to the queries, on a higher periodic base, i.e., more frequently. No communication to the doctor may be required at this time, although the computer program or software may be instructed to provide the medical professional with a summary of action taken.

It has been discovered that with regard to hormone replacement therapy, patients do not receive appropriate care in some instances due to several barriers that exist with regard to continuation of this type of therapy. First, patients tend to utilize drug therapies for symptomatic relief only and receive inadequate up-to-date information regarding the long-term benefits for therapies such as hormone replacement therapy, which is useful in the prevention and treatment of osteoporosis or heart disease, or therapy for hypertension which results in avoidance of stroke and cardiovascular disease. Often, patients stop therapy prematurely once symptoms are alleviated or upon occurrence of uncomfortable side effects. Further, it is believed that medical professionals do not receive timely feedback on therapy effectiveness issues such as control of vasomotor symptoms or symptoms of vaginal atrophy. In addition, oftentimes, medical professionals do not receive timely feedback on patient adverse side effects such as breakthrough bleeding, breast tenderness, or sexual dysfunction. Finally, physicians have difficulty receiving timely feedback on patient dosing compliance. Communication often breaks down between patient and medical professional.

In effect, the present invention enables both the patient and her medical professional to receive information useful to maintaining therapy for the term needed. By providing an interactive method and system, the patient and the doctor have access to needed information in an efficient and convenient manner not requiring repeated office visits. The ability of the system of the invention to analyze the information provides a great advantage to users and their physicians. The system of the invention is designed to alert the appropriate individual when problems arise or provide additional educational information as needed.

The information system of the present invention may also be used in post and pre-approval clinical trials to assess the effectiveness of an experimental or marketed hormone replacement therapy and to compile and assess patient symptoms, side effects and safety of the therapy. In this manner the information system may be useful in obtaining FDA approval for and/or monitoring new hormone replacement therapies. In addition, the information system of the present invention may be used as a marketing tool for particular hormone replacement agents. In this regard, the information system may be used to track market share and the information system may be used to promote use of the particular drug since if that drug is prescribed the patient also gains access to the system. Further, the information system may be used to compare different hormone replacement agents and assess the advantages and disadvantages of the different agents. This information system may also be used in Phase IV trials.

The invention will be further explained by the following illustrative examples which are intended to be non-limiting.

### EXAMPLE 1

### Monitoring Hot Flashes

To monitor hot flashes, a patient with an account on the information system and access to the system may select to input information concerning hot flashes that she has experienced in the past week. The patient may be prompted to input information into a weekly log as shown in Table 1a and 1b.

TABLE 1a
Hot Flashes Input
Weekly Log

| | Mild | Moderate | Severe |
|---|---|---|---|
| Hot Flashes | <3 | 3-8 | >8 |
| Frequency | 1 2 3 4 5 6 7 | 1 2 3 4 5 6 7 | 1 2 3 4 5 6 7 |
| Severity Mild | 1 2 3 4 5 6 7 | 1 2 3 4 5 6 7 | 1 2 3 4 5 6 7 |
| Moderate | 1 2 3 4 5 6 7 | 1 2 3 4 5 6 7 | 1 2 3 4 5 6 7 |
| Severe | 1 2 3 4 5 6 7 | 1 2 3 4 5 6 7 | 1 2 3 4 5 6 7 |

For Sunday, circle or click on 1 for frequency, indicating the number of hot flashes, i.e., if less than 3 hot flashes were experienced circle or click on 1 under mild. If these hot flashes were severe, then circle or click on 1 under severe under the Mild in the severe row.

TABLE 1b
Hot Flashes Input
Weekly Log

| | | | |
|---|---|---|---|
| Patient Assessment | | | |
| Day | Acceptable | Troublesome | Unacceptable |

1. Sunday
2. Monday
3. Tuesday
4. Wednesday
5. Thursday
6. Friday
7. Saturday

The information may be input electronically by pointing and clicking or the information may be entered by manually filling out the table, or marking an optically scanned instrument.

The patient may be prompted to quantify the number of hot flashes she has experienced each day, and the patient may be asked to rate the severity of the hot flashes each day as mild, moderate or severe. The patient may also be asked to assess the number and severity of the hot flashes that she is experiencing each day as acceptable, troublesome, or unacceptable.

The information system may manipulate and analyze the information that the patient has input as illustrated in FIG. 3. The information system may calculate an average number of hot flashes per day and an average severity (mild, moderate, or severe). Current practice describes mild hot flashes as the subject having a sensation of heat but has no perspiration associated with it. During a moderate hot flash the subject has a sensation of heat with perspiration, but has no discontinuation of activity. A severe hot flash is described as a sensation of heat with sweating which results in a discontinuation of activity. Discontinuation of activity can be very brief, such as stopping to briefly fan or wipe one's brow. Waking from sleep due to a hot flash is therefore also described as a severe hot flash.

Using the average frequency and the average severity, a number may be assigned. For example, the patient may input data such that the average number of hot flashes that she is experiencing a day is 3-8 and the patient may input data such that the average severity of her hot flashes per day is severe. Using this data, the information system may assign the number 12.

The patient may also input data indicating that she assesses the hot flashes to be troublesome. Based on this assessment, the information system may determine not to adjust the number and assign a final score of 12 to the patient's hot flash data. Based on a final score of 12, the information system may send a communication to the patient recommending that she schedule an appointment with her medical professional and may send a communication to the medical professional comprising a weekly summary of the patient's hot flash symptoms and an advisory that the patient should schedule an appointment with the medical professional.

### EXAMPLE 2

### Monitoring Breakthrough Bleeding

To monitor breakthrough bleeding, a patient with an account on the information system and access to the system may select to input information concerning breakthrough bleeding that she has experienced in the past month. The patient may be prompted to input information into a monthly log. The information may be input electronically by pointing and clicking or the information may be entered manually.

The patient may be prompted to quantify the number of days that she has experienced bleeding that month, and the patient is asked to rate the severity of the bleeding as spotting, slight, moderate, or heavy. The patient may also be asked to assess the number and severity of the bleeding that she is experiencing as acceptable, troublesome, or unacceptable. Bleeding is generally characterized on a five point scale, 0 to 4. No bleeding at all is characterized as 0. Spotting which requires no use of sanitary protection is a 1. Spotting which requires the use of some sort of sanitary protection is a 2. Moderate bleeding is a 3, and heavy bleeding is a 4.

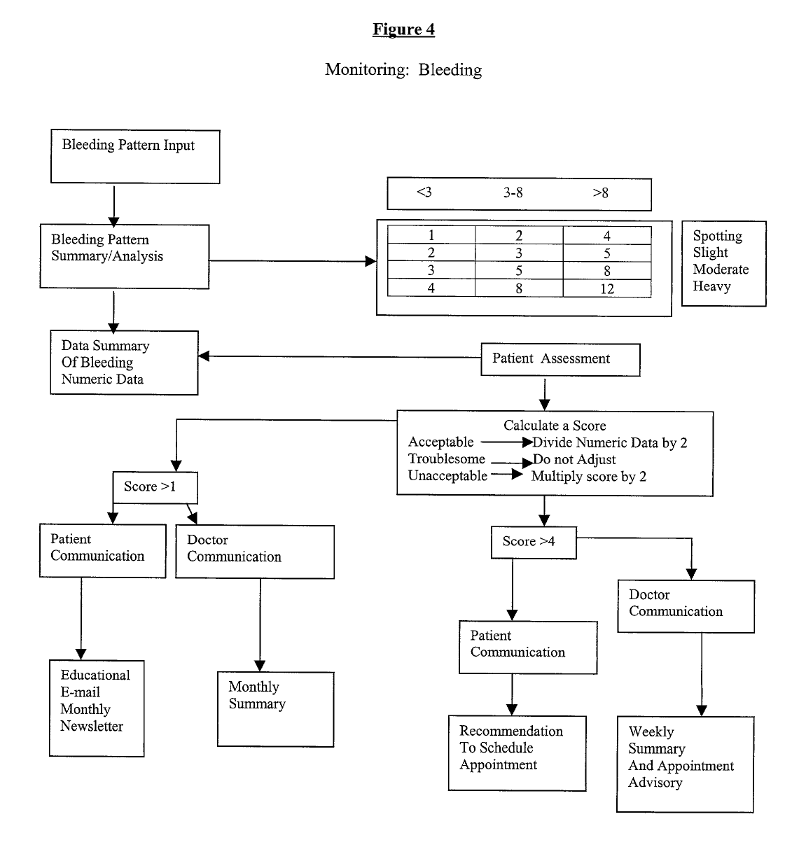

The information system may manipulate and analyze the information that the patient has input as illustrated in FIG. 4. The information system may calculate the number of days bleeding per month and an average severity (spotting, slight, moderate, or heavy). Using the number of days bleeding and the average severity, a number may be assigned. For example, the patient may input data such that the number of days that she is experiencing bleeding is 3-8 and the patient may input data such that the average severity of her bleeding is spotting. Using this data, the information system may assign the number 2.

The patient may also input data indicating that she assesses the bleeding to be acceptable. Based on this assessment, the information system may divide the number assigned (2) by 2 to calculate a final score of 1. Based on a final score of 1, the information system may send an educational email communication to the patient concerning breakthrough bleeding.

Various modifications and alterations of this invention will become apparent to those skilled in the art without departing from the scope and spirit of this invention.

That which is claimed is:

1. A method for monitoring compliance with or effectiveness of hormone replacement therapy comprising:
(a) initiating a patient account with an automated, interactive information system comprising an information database;
(b) posing one or more queries comprising symptoms of menopause during hormone replacement therapy, side effects of hormone replacement therapy, or compliance in patient administration of hormone replacement therapy, said queries to be answered by the patient on a regular basis;
(c) inputting responses to the queries into the information database;
(d) compiling the responses to the queries in the information database;
(e) automatically converting the responses into digital data using the information system;
(f) automatically analyzing the digital data to generate a hormone replacement patient acceptability score for hormone replacement therapy;
(g) automatically generating patient information and medical professional information using the information system;
(h) automatically providing the patient information to the patient; and
(i) automatically providing the medical professional information to a medical professional.

2. The method of claim 1, wherein a visit to a medical professional is used to initiate a patient account with the information system.

3. The method of claim 1, comprising an additional step of activating the patient account with the information system by having a pharmacist fill a prescription for hormone replacement agents and the pharmacist sending a rebate to the information system.

4. The method of claim 1, wherein the queries are directed to one or more of vasomotor symptoms, osteoporosis markers, declining libido, sexual dysfunction, vaginal dryness, vaginal atrophy, reddening of the skin on the face, neck and chest, joint pain, urinary incontinence, skin dryness, dizziness, headache, weakness, mental anguish, depression, inability to concentrate, memory loss, insomnia, nervousness, irritability, abrupt mood swings, breakthrough bleeding, migraines, weight gain, breast tenderness, bloating, hypertension, nausea, vomiting, diarrhea, or leg cramps.

5. The method of claim 1, wherein the queries are directed to dosing compliance by the patient to a prescribed hormone replacement agent.

6. The method of claim 4, wherein the queries are directed to side effects to a prescribed hormone replacement agent experienced by the patient.

7. The method of claim 4, wherein the queries are directed to symptoms of menopause suffered by the patient.

8. The method of claim 1, wherein the patient information is selected from the group consisting of summaries, educational quarterly newsletters, educational monthly newsletters, educational materials relating to a specific a area of concern, a notification to consult medical professionals, a notification that the symptoms or side effects are abnormal, and a notification to discontinue medication.

9. The method of claim 1, wherein the medical professional information is selected from the group consisting of monthly summaries of patient side effects, symptoms, and dosing compliance; weekly summaries of patient side effects, symptoms, and dosing compliance; a notification that the patient is suffering from a particular side effect; a notification that the patient is suffering from a particular symptom; and a notification to contact the patient to schedule an appointment.

10. The method of claim 1 further comprising as steps:
automatically analyzing the digital data to generate pharmacist information; and
automatically providing the pharmacist information to the pharmacist.

11. The method of claim 1 wherein both compliance with and effectiveness of hormone replacement therapy is monitored.

12. The method of claim 1, further comprising screening the analyzed data against one or more predetermined treatment paradigms.

13. The method of claim 12, further comprising performing a statistical analysis on the analyzed data and modifying the predetermined treatment paradigms based on the statistical analysis.

14. A method for monitoring compliance with or effectiveness of hormone replacement therapy comprising:
(a) initiating a patient account with an automated, interactive information system comprising an information database;
(b) providing a patient code to allow patient access to the system;
(c) establishing patient access to the system;
(d) posing one or more queries comprising symptoms of menopause during hormone replacement therapy, side effects of hormone replacement therapy, or compliance in patient administration of hormone replacement therapy, said queries to be answered by the patient on a regular basis;
(e) inputting responses to the queries into the information database;
(f) compiling the responses to the queries in the information database;
(g) automatically converting the responses into digital data using the information system;
(h) automatically analyzing the digital data to generate patient information and medical professional information using the information system;
(i) automatically providing the patient information to the patient; and
(j) automatically providing the medical professional information to the medical professional.

15. The method of claim 14, wherein the information system is further comprised of a primary computer on which the information system is maintained and one or more remote terminals or computers interactively integrated with the information system.

16. The method of claim 14, further comprising a step of issuing a pharmacist rebate payable to the pharmacist who fills a prescription of hormone replacement agents for the patient.

17. The method of claim 14, wherein the patient access to the system is established by a pharmacist who fills a prescription for hormone replacement agents.

18. The method of claim 14, further comprising screening the analyzed data against one or more predetermined treatment paradigms.

19. The method of claim 14, wherein the queries are directed to one or more of vasomotor symptoms, osteoporosis markers, declining libido, sexual dysfunction, vaginal dryness, vaginal atrophy, reddening of the skin on the face, neck and chest, joint pain, urinary incontinence, skin dryness, dizziness, headache, weakness, mental anguish, depression, inability to concentrate, memory loss, insomnia, nervousness, irritability, abrupt mood swings, breakthrough bleeding, migraines, weight gain, breast tenderness, bloating, hypertension, nausea, vomiting, diarrhea, or leg cramps.

20. A method for monitoring compliance with or effectiveness of hormone replacement therapy comprising:
(a) initiating a patient account with an automated, interactive information system comprising an information database;
(b) posing one or more queries to be answered by the patient on a regular basis;
(c) inputting responses to the queries into the information database;
(d) compiling the responses to the queries in the information database;
(e) automatically converting the responses into digital data using the information system;
(f) automatically analyzing the digital data to generate a hormone replacement therapy patient acceptability score;
(g) automatically generating patient information and medical professional information using the information system;
(h) automatically providing the patient information to the patient; and
(i) automatically providing the medical professional information to a medical professional.

21. The method of claim 20, wherein the queries are directed to dosing compliance by the patient to a prescribed hormone replacement agent; side effects to a prescribed hormone replacement agent experienced by the patient; or symptoms of menopause suffered by the patient.

22. The method of claim 20, wherein the hormone replacement therapy patient acceptability score is used to permit relative assessment of one patient's symptoms, side effects of hormone replacement therapy and compliance with therapy against hormone replacement patient acceptability scores of other patients as collected by the information system or provided by known treatment paradigms.

23. An automated, interactive system for monitoring compliance with or effectiveness of hormone replacement therapy comprising:
(a) a means for posing one or more queries relevant to hormone replacement therapy to a patient;
(b) a means for inputting responses to the queries into an information database;
(c) a means for storing the responses;
(d) a means for manipulating the responses to obtain an assessment of the patient relevant to hormone replacement therapy; and
(e) a means for providing information based on the assessment to medical professionals and to the patient.

24. An automated, interactive system for monitoring compliance with or the effectiveness of hormone replacement therapy comprising:
(a) a primary computer system;
(b) an information database stored on the primary computer;
(c) an input device for receiving and transferring information from a patient to the information database;
(d) a computer program for manipulating the information to generate an assessment of the information resulting in a hormone replacement patient acceptability score; and
(e) an output device for providing information based on the assessment to a patient and a medical professional monitoring the patient's care.

25. The automated, interactive information system of claim 24, further comprising one or more remote terminals or computers interactively integrated with the primary computer and the information database stored on the primary computer.

26. The automated, interactive information system of claim 24, wherein the information from the patient is obtained from responses provided by the patient to queries posed by the information system.

27. The automated, interactive information system of claim 24, wherein the input device is a computer.

28. The automated, interactive information system of claim 24, wherein the output device is a printer.
